(19) United States
(12) Patent Application Publication
(10) Pub. No.: US 2017/0001616 A1
(43) Pub. Date: Jan. 5, 2017

(54) PERMANENT MAGNET TYPE ELECTROMAGNETIC BRAKING CYLINDER

(71) Applicant: MIKTECH CO., LTD., Seoul (KR)

(72) Inventors: Min-Jung KWON, Goyang-si (KR); Sung-Ho JU, Goyang-si (KR); Kyoung-Cheon YOU, Gwangju (KR); Suk-Soon YOUN, Seoul (KR)

(73) Assignee: MIKTECH CO., LTD., Seoul (KR)

(21) Appl. No.: 15/104,968

(22) PCT Filed: Dec. 2, 2014
(86) PCT No.: PCT/KR2014/011681

§ 371 Date: Jun. 15, 2016

(30) Foreign Application Priority Data
Dec. 16, 2013 (KR) 10-2013-0156710

(51) Int. Cl. B60T 13/74; B61H 13/00

(52) U.S. Cl. CPC B60T 13/748; B61H 13/00

(57) ABSTRACT

An electromagnetic braking cylinder includes a cylinder part, a piston part and an electromagnetic force generating part. The cylinder part includes first and second surfaces and an extending portion. The first and second surfaces face each other and form a first receiving space. The extending portion vertically extends from the second surface and forms a second receiving space. The piston part is received inside of the first and second receiving spaces, and moves back and forth along the extending part. The electromagnetic force generating part includes first and second electromagnetic parts respectively fixed to the cylinder part and the piston part, and moves the piston part according as an electromagnetic force is applied. One of the first and second electromagnetic parts includes a permanent magnet.

### BACKGROUND

1. Field of Disclosure

The present disclosure of invention relates to an electromagnetic braking cylinder. More particularly, the present disclosure of invention relates to an electromagnetic braking cylinder using a permanent magnet.

2. Description of Related Technology

Conventionally, a braking cylinder used for a railway vehicle or a large vehicle is a pneumatic cylinder using a pneumatic pressure or a hydraulic cylinder using a hydraulic pressure, and thus the conventional braking cylinder provides the pneumatic pressure or the hydraulic pressure on a pressured surface for braking.

However, the pneumatic cylinder or the hydraulic cylinder needs additional elements to provide the pneumatic pressure or the hydraulic pressure, and thus pipe lines or connecting lines circulating the pneumatic pressure or the hydraulic pressure to a braking part are necessary. Thus, in the braking cylinder, the pipe lines or the connecting lines should be optimally designed, and the space for the braking cylinder or the additional elements may be increased.

For example, in Korean laid-open patent No. 10-1998-0062256 or No. 10-2001-0030858, the braking cylinder using the hydraulic pressure is disclosed, but a structure of the braking cylinder is complicated and a volume of the braking cylinder is increased. Thus, the disclosed braking cylinder is not proper to a trend of a recent light and simple vehicle design.

Accordingly, a braking cylinder instead of using the pneumatic pressure of the hydraulic pressure is recently developed.

### SUMMARY

The present invention is developed to solve the above-mentioned problems of the related arts. The present invention provides an electromagnetic braking cylinder capable of reducing a weight of the vehicle, simplifying a design of the vehicle and improving a design of the vehicle.

According to an example embodiment, an electromagnetic braking cylinder includes a cylinder part, a piston part and an electromagnetic force generating part. The cylinder part includes first and second surfaces and an extending portion. The first and second surfaces face each other and form a first receiving space. The extending portion vertically extends from the second surface and forms a second receiving space. The piston part is received inside of the first and second receiving spaces, and moves back and forth along the extending part. The electromagnetic force generating part includes first and second electromagnetic parts respectively fixed to the cylinder part and the piston part, and moves the piston part according as an electromagnetic force is applied. One of the first and second electromagnetic parts includes a permanent magnet.

In an example embodiment, the piston part may include a bottom portion and an axis portion. The bottom portion may be received by the first receiving space, may divide the first receiving space into first and second sub receiving spaces, and may extend parallel with the first and second surfaces. The axis portion may be received by the second sub receiving space and the second receiving space, and may extend parallel with the extending portion.

In an example embodiment, the first electromagnetic part may be fixed to the first surface and the second electromagnetic part may be fixed to the bottom portion, and thus the first and second electromagnetic parts may be disposed facing each other in the first sub receiving space.

In an example embodiment, the electromagnetic braking cylinder may further include an elastic element fixed to the second sub receiving space between the bottom portion and the second surface.

In an example embodiment, one of the first and second electromagnetic parts may be a permanent magnet, and the remaining of the first and second electromagnetic parts may be an electromagnet or a hybrid electromagnet.

In an example embodiment, the electromagnetic braking cylinder may further include a control part changing a current or a voltage applied to the electromagnetic force generating part to control an intensity of an electromagnetic force of the electromagnetic force generating part.

In an example embodiment, the electromagnetic braking cylinder may further include a heat dissipating part connected to the electromagnetic force generating part and dissipating a heat generated from the electromagnetic force generating part.

In an example embodiment, the electromagnetic braking cylinder may further include a control unit connected to the piston part and applying a pressure to a target part to control the target part.

According to the example embodiments of the present invention, a first electromagnetic part and a second electromagnetic part of an electromagnetic force generating part is fixed to a cylinder part and a piston part, and an electromagnetic force is applied to move the piston part and the cylinder part relatively. Thus, a predetermined pressure may be applied to a target part via a braking unit connected to the piston part.

A pneumatic line or a hydraulic line for providing the pressure may be omitted, a braking cylinder may be more simply designed, the braking cylinder may be lightly designed, and the braking cylinder may be minimized.

One of the first and second electromagnetic parts includes a permanent magnet and a current or a voltage is applied to the other of the first and second electromagnetic parts, to generate the electromagnetic force. Thus, a control may be relatively easy, a heat generated due to the current or the voltage may be decreased, and additional elements for applying the current or the voltage may be designed more simply.

In addition, the current or the voltage applied to the electromagnetic force generating part is variably controlled and a size or a time of the pressure applied to the target part may be controlled, and thus the control may be simplified.

In addition, the piston part moves outside of the cylinder part due to a repulsive force between the first and second electromagnetic parts and thus the pressure is applied to the target part. The piston part moves inside of the cylinder part due to an attractive force between the first and second electromagnetic parts and thus the pressure is not applied to the target part. Thus, the force may be easily applied to the target part.

Alternatively, the pressure applied to the target part may stop due to a recuperative force of an elastic element, and thus the force may be easily applied to the target part with a simple structure.

In addition, one of the first and second electromagnetic parts includes a permanent magnet and the other of the first and second electromagnetic parts includes a hybrid electromagnet instead of a general electromagnet, and various kinds of combination may be simply used.

Further, a heat generated duet to the current or the voltage may be efficiently dissipated via a heat dissipating part connected to the electromagnetic force generating part, and thus durability and performance reliability may be increased.

### BRIEF DESCRIPTION OF THE DRAWINGS

FIG. 1 is a block diagram illustrating an electromagnetic braking cylinder according to an example embodiment of the present invention;

FIG. 2 is a cross-sectional view illustrating an electromagnetic braking cylinder of FIG. 1;

FIG. 3 is a cross-sectional view illustrating an operation of the electromagnetic braking cylinder according to an electromagnetic force; and

FIG. 4 is a cross-sectional view illustrating an electromagnetic braking cylinder according to another example embodiment of the present invention.

Reference numerals

| | |
|---|---|
| 10: electromagnetic braking cylinder | 100: control part |
| 200: cylinder part | 201: first receiving space |
| 202: first sub receiving space | 203: second sub receiving space |
| 204: second receiving space | 210: first surface |
| 220: second surface | 230: side portion |
| 240: extending portion | 300: electromagnetic force |
| | generating part |
| 310: first electromagnetic part | 320: second electromagnetic part |
| 350: heat dissipating part | 400: piston part |
| 410: bottom portion | 420: axis portion |
| 450: elastic element | 500: braking unit |
| 600: target part | |

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. It will be understood that, although the terms first, second, third etc. may be used herein to describe various elements, components, regions, layers and/or sections, these elements, components, regions, layers and/or sections should not be limited by these terms.

These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiment of the invention will be explained in detail with reference to the accompanying drawings.

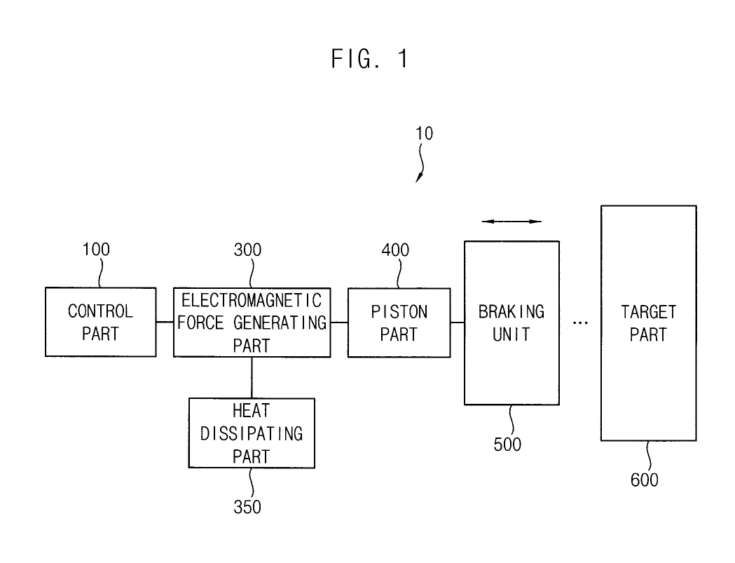

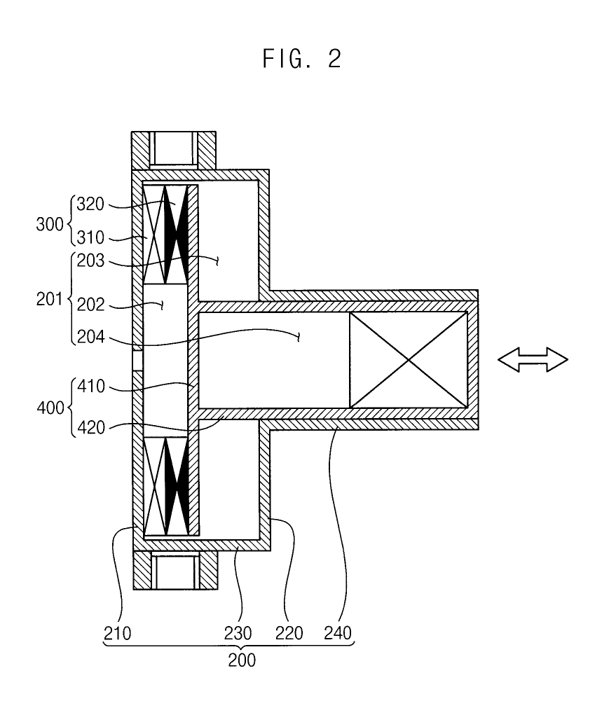

FIG. 1 is a block diagram illustrating an electromagnetic braking cylinder according to an example embodiment of the present invention. FIG. 2 is a cross-sectional view illustrating an electromagnetic braking cylinder of FIG. 1.

Referring to FIG. 1, the electromagnetic braking cylinder 10 includes a control part 100, a cylinder part 200, an electromagnetic force generating part 300, a heat dissipating part 350, a piston part 400 and a braking unit 500.

In the present example embodiment, the piston part 400 moves due to an electromagnetic force generated from the electromagnetic force generating part 300, and the control part 100 controls an intensity or an applied time of the electromagnetic force generated from the electromagnetic force generating part 300.

For example, the control part 100 switches a current or a voltage for generating the electromagnetic force, or controls the applied time of the current or the voltage, and thus the intensity of a final pressure or the applied time applied due to the piston part 400.

The electromagnetic force generating part 300, as explained below, includes first and second electromagnetic parts 310 and 320, and in the present example embodiment, one of the first and second electromagnetic parts 310 and 320 includes a permanent magnet. Accordingly, the current or the voltage is enough to be applied to a remaining of the first and second electromagnetic parts 310 and 320, and the current or the voltage applied to the remaining of the first and second electromagnetic parts 310 and 320 is enough to be switched or the applied time of the current or the voltage applied to the remaining of the first and second electromagnetic parts 310 and 320 is enough to be controlled.

The electromagnetic force generating part 300 generates the electromagnetic force based on a signal of the current or the voltage from the control part 100, and moves the piston part 400 with respect to the cylinder part 200. Here, a moving direction of the piston part 400 may be switched according to a direction of the electromagnetic force and a kind of the electromagnetic force generating part 300. For example, the moving direction may be back and forth.

When the current or the voltage is applied to the electromagnetic force generating part 300 to generate the electromagnetic force, a temperature of the electromagnetic force generating part 300 is increased and thus a malfunction of the electromagnetic force generating part 300 may occur and a reliability of the electromagnetic force generating part 300 may be decreased.

In the present example embodiment, the electromagnetic braking cylinder 10 includes a heat dissipating part 350, and the heat dissipating part 350 is disposed adjacent to the electromagnetic force generating part 300 or makes direct contact with the electromagnetic force generating part 300. Thus, the heat generated from the electromagnetic force generating part 300 is efficiently dissipated.

As explained above, in the present example embodiment, one of the first and second electromagnetic parts 310 and 320 includes a permanent magnet, and thus the remaining of the first and second electromagnetic parts 310 and 320 may be heated due to the current or the voltage. Thus, the heat dissipating part 350 may be disposed adjacent to or make direct contact with one of the first and second electromagnetic parts 310 and 320.

The piston part 400 moves with respect to the cylinder part 200 due to the electromagnetic force from the electromagnetic force generating part 300 and applies the pressure to outside, and thus a proper movement may be performed.

Here, the braking may be performed according to the movement of the piston part 400, and thus the electromagnetic barking cylinder 10 includes the braking unit 500. For example, when the piston part 400 moves, the braking unit 500 connected to the piston part 400 moves along an arrow direction as illustrated in FIG. 1. When the braking unit 500 moves along the arrow direction, an operation of the target part 600 may be controlled.

For example, when the target part 600 is a wheel of a railway vehicle or a large vehicle, the braking unit 500 moves toward a target surface of the target part 600 to increase a friction force with the target surface and to decrease a rotation of the wheel, and thus the wheel stops. Likewise, when the braking unit 500 moves opposite to the target surface, the friction force with the target surface is decreased and thus the wheel rotates again.

Accordingly, the piston part 400 is connected to the braking unit 500, to brake the wheel when the target part 600 is a wheel.

Alternatively, the target part 600 may be a various kinds of operation units except for the wheel, and the braking unit 500 applies the pressure or the friction force to the target part 600 to control the operation of the target part 600.

Hereinafter the electromagnetic braking cylinder 10 will be explained in detail referring to FIG. 2. The cylinder part 200 includes first and second surfaces 210 and 220 facing each other, a side portion 230 and an extending portion 240.

The first surface 210 forms a first end surface of the cylinder part 200, and although not shown in FIG. 2, has a circular plate or a polygonal plate.

The second surface 220 faces the first surface 210, and is spaced apart from the first surface 210 by a predetermined distance. The second surface 220 has a circular plate or a polygonal plate with an opening portion at a central portion of the second surface 220. Here, when the first surface 210 is the circular plate, the second surface 220 is the circular plate. Thus, the shape of the first surface 210 may be same as that of the second surface 220.

An end portion, a circumference or an edge of the first surface 210 is connected that of the second surface 220, via the side portion 230. For example, when the first and second surfaces 210 and 220 are circular plates, the side portion 230 connects the circumference of the first surface 210 with the circumference of the second surface 220.

Thus, a first receiving space 201 is formed inside of the first and second surfaces 210 and 220, and the side portion 230.

The extending portion 240 extends from a center of the second surface 220, and an extending direction of the extending portion 240 may be perpendicular to an extending direction of the first surface 210 or the second surface 220. For example, a first end portion of the extending portion 240 extends from an opening of the second surface 220 at the center, and thus the cylinder part 200 entirely forms a T shape cross-section.

A second end portion of the extending portion 240 is opened, and thus the piston part 400 moves through the opening.

In addition, the extending portion 240 as a cylindrical shape or a polyprism shape, and thus a second receiving space 204 is formed inside of the extending portion 240.

The piston part 400 includes a bottom portion 410 and an axis portion 420.

The bottom portion 410 is received inside of the first receiving space 201, and has a plat shape substantially same as the first surface 210. The bottom portion 410 is smaller than the first surface 210, to be received by the first receiving space 201.

The bottom portion 410 is disposed at a central portion of the first receiving space 201, to divide the first receiving space 201 into first and second sub receiving spaces 202 and 203. Here, as explained below, the electromagnetic force generating part 300 is disposed in the first receiving space 201.

The axis portion 420 extends from a center of the bottom portion 410, and extends along an extending direction of the extending portion 240. The axis portion 420 may be received in both the first and second receiving spaces 201 and 204, and a radius of the axis portion 420 is smaller than that of the extending portion 240.

The axis portion 420 extends from the bottom portion 410 toward the second receiving space 204, and thus the axis portion 420 is received in the second sub receiving space 203.

The piston part 400 moves along the arrow direction as illustrated in figure, in the first and second receiving spaces 201 and 204 inside of the cylinder part 200, and thus, the axis portion 420 may be exposed through the opening formed through the second end portion of the extending portion 240.

The electromagnetic force generating part 300 includes a first electromagnetic part 310 and a second electromagnetic part 320.

As explained above, one of the first and second electromagnetic parts 310 and 320 is a permanent magnet, and the remaining of the first and second electromagnetic parts 310 and 320 may be a general magnet or a hybrid magnet. Hereinafter, for example, the second electromagnetic part 320 is assumed to be the permanent magnet.

The first electromagnetic part 310 is fixed to the first surface 210 of the cylinder part 200, and the second electromagnetic part 320 is fixed to the bottom portion 410 of the piston part 400. The first and second electromagnetic parts 310 and 320 face each other.

For example, the first electromagnetic part 310 is fixed along an outer surface of the first surface 210 at a position facing the bottom portion 410, and the second electromagnetic part 320 is fixed along an outer surface of the bottom portion 410 at a position facing the first surface 210. Here, when the first surface 210 and the bottom plate 410 is circular plate shapes, each of the first and second electromagnetic parts 310 and 320 may be a circular doughnut shape.

Accordingly, the first and second electromagnetic parts 310 and 320 face each other, and the first surface 210 and the bottom portion 410 moves relatively due to the electromagnetic force generated by the first and second electromagnetic parts 310 and 320. Thus, the piston part 400 moves inside of the cylinder part 200.

For example, the second electromagnetic part 320 is the permanent magnet and the current or the voltage is applied to the first electromagnetic part 310, and thus the electromagnetic force is generated between the first and second electromagnetic parts 310 and 320 and the thus piston part 400 moves inside of the cylinder part 200.

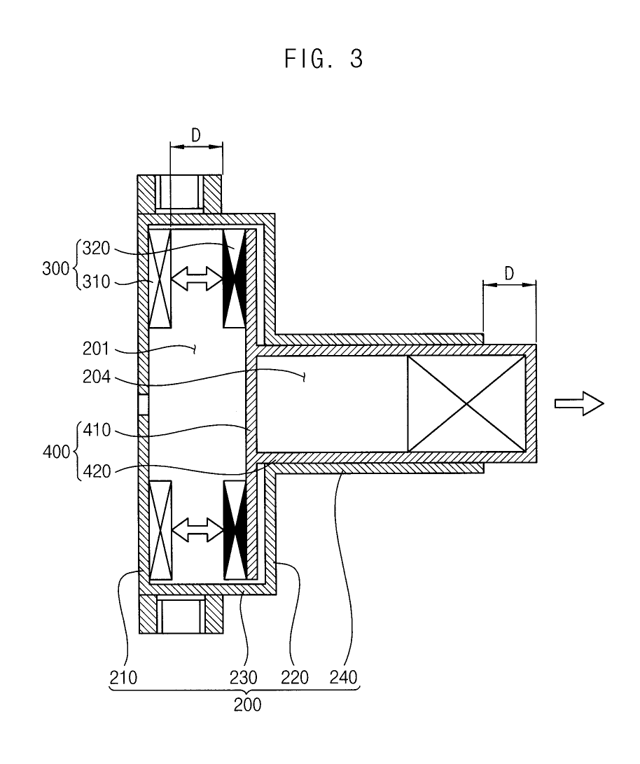

FIG. 3 is a cross-sectional view illustrating an operation of the electromagnetic braking cylinder according to an electromagnetic force.

Referring to FIGS. 2 and 3, in the present example embodiment of the electromagnetic braking cylinder 10, an input on an intensity of the current or the voltage and an applied time of the current or the voltage is provided to the electromagnetic force generating part 300 based on an operation signal of the control part 100, and the electromagnetic force generating part 300 generates the electromagnetic force.

For example, based on the input, the electromagnetic force is generated from the first electromagnetic part 310 and a repulsive force is generated between the first and second electromagnetic parts 310 and 320, and thus the bottom portion 410 moves toward the second surface 220 and the piston part 400 moves along the arrow direction as illustrated in FIG. 3 inside of the cylinder part 200.

Here, a moving distance D of the piston part 400 is substantially same as a maximum space distance between the first and second electromagnetic parts 310 and 320. For example, the moving distance D depends on the space distance between the first and second surfaces 210 and 220.

Then, the direction of the current or the voltage applied to the first electromagnetic part 310 is switched to generate an attractive force between the first and second electromagnetic parts 310 and 320, and thus the bottom portion 410 moves toward the first surface 210 from the second surface 220. Thus, the piston part 400 is returned to the position as illustrated in FIG. 2.

Further, if necessary, the direction of the current or the voltage applied to the first electromagnetic part 310 is switched to generate the attractive force and the repulsive force in turn, and thus the piston part 400 moves back and forth inside of the cylinder part 200.

Accordingly, as the piston part 400 moves back and forth, the braking unit 500 connected to the end portion of the piston part 400 moves back and forth and the pressure from the piston part 400 is transferred to the target part 600 through the braking unit 500. Thus, the target part 600 operates or moves with a predetermined motion.

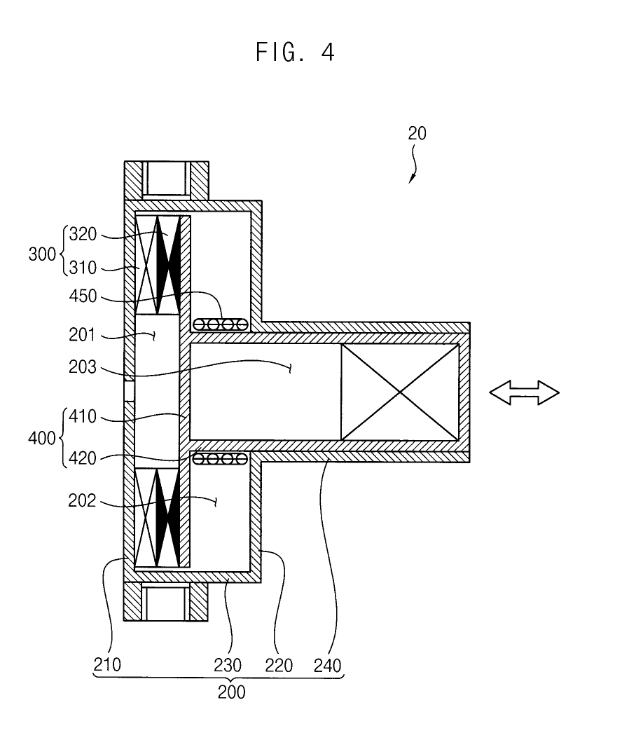

FIG. 4 is a cross-sectional view illustrating an electromagnetic braking cylinder according to another example embodiment of the present invention.

The electromagnetic braking cylinder 20 according to the present example embodiment is substantially same as the electromagnetic braking cylinder 10 according to the previous example embodiment in FIGS. 1 to 3, except for an elastic element 450, and thus same reference numerals are used and a repetitive explanation will be omitted.

Referring to FIG. 4, the electromagnetic braking cylinder 20 according to the present example embodiment further includes the elastic element 450 fixed between the bottom portion 410 and the second surface 220. For example, the elastic element 450 is disposed in the second sub receiving space 202, and is disposed in a space divided from the first and second electromagnetic parts 310 and 320.

For example, the elastic element 450 is fixed to an outer surface of the axis portion 420 spaced apart from the end portion of the axis portion 420 fixed to the bottom portion 410 by a predetermined distance. For example, a first end portion of the elastic element 450 is fixed to the bottom portion 410, and a second end portion of the elastic element 450 is fixed to the second surface 220, and thus the bottom portion 410 and the second surface 220 are supported by an elastic force of the elastic element 450.

Here, the elastic element 450 may be a spring.

In the electromagnetic braking cylinder 20, as explained above for the electromagnetic braking cylinder 10, an input on an intensity of the current or the voltage and an applied time of the current or the voltage is provided to the electromagnetic force generating part 300 based on an operation signal of the control part 100, and the electromagnetic force generating part 300 generates the electromagnetic force.

For example, based on the input, the electromagnetic force is generated from the first electromagnetic part 310 and a repulsive force is generated between the first and second electromagnetic parts 310 and 320, and thus the bottom portion 410 moves toward the second surface 220 and the piston part 400 moves along the arrow direction as illustrated in FIG. 3 inside of the cylinder part 200.

However, in the present example embodiment, the elastic element 450 is pressed to have a predetermined elastic force as the bottom portion 410 moves toward the second surface 220.

Then, the current or the voltage is not applied to the first electromagnetic part 310 and the repulsive force 320 between the first and second electromagnetic parts 310 and 320 is extinguished, and then the bottom portion 410 moves detached from the second surface 220 due to the elastic force of the elastic element 450 fixed between the bottom portion 410 and the second surface 220. Thus, the piston part 400 is returned to the position as illustrated in FIG. 2.

Accordingly, in the present example embodiment, an additional current or voltage is unnecessary to generate the attractive force between the first and second electromagnetic parts 310 and 320, and the piston part 400 may return to the position as illustrated in FIG. 4 due to the elastic force of the elastic element 450.

Likewise, in the electromagnetic braking cylinder 20 according to the present example embodiment, as the piston part 400 moves back and forth, the braking unit 500 connected to the end portion of the piston part 400 moves back and forth and the pressure from the piston part 400 is transferred to the target part 600 through the braking unit 500. Thus, the target part 600 operates or moves with a predetermined motion.

According to the example embodiments of the present invention, a first electromagnetic part and a second electromagnetic part of an electromagnetic force generating part is fixed to a cylinder part and a piston part, and an electromagnetic force is applied to move the piston part and the cylinder part relatively. Thus, a predetermined pressure may be applied to a target part via a braking unit connected to the piston part.

A pneumatic line or a hydraulic line for providing the pressure may be omitted, a braking cylinder may be more simply designed, the braking cylinder may be lightly designed, and the braking cylinder may be minimized.

One of the first and second electromagnetic parts includes a permanent magnet and a current or a voltage is applied to the other of the first and second electromagnetic parts, to generate the electromagnetic force. Thus, a control may be relatively easy, a heat generated due to the current or the voltage may be decreased, and additional elements for applying the current or the voltage may be designed more simply.

In addition, the current or the voltage applied to the electromagnetic force generating part is variably controlled and a size or a time of the pressure applied to the target part may be controlled, and thus the control may be simplified.

In addition, the piston part moves outside of the cylinder part due to a repulsive force between the first and second electromagnetic parts and thus the pressure is applied to the target part. The piston part moves inside of the cylinder part due to an attractive force between the first and second electromagnetic parts and thus the pressure is not applied to the target part. Thus, the force may be easily applied to the target part.

Alternatively, the pressure applied to the target part may stop due to a recuperative force of an elastic element, and thus the force may be easily applied to the target part with a simple structure.

In addition, one of the first and second electromagnetic parts includes a permanent magnet and the other of the first and second electromagnetic parts includes a hybrid electromagnet instead of a general electromagnet, and various kinds of combination may be simply used.

Further, a heat generated duet to the current or the voltage may be efficiently dissipated via a heat dissipating part connected to the electromagnetic force generating part, and thus durability and performance reliability may be increased.

The foregoing is illustrative of the present teachings and is not to be construed as limiting thereof. Although a few exemplary embodiments have been described, those skilled in the art will readily appreciate from the foregoing that many modifications are possible in the exemplary embodiments without materially departing from the novel teachings and advantages of the present disclosure of invention. Accordingly, all such modifications are intended to be included within the scope of the present teachings. In the claims, means-plus-function clauses are intended to cover the structures described herein as performing the recited function and not only structural equivalents but also functionally equivalent structures.

The electromagnetic braking cylinder may be used to a braking part of a railway vehicle or a large vehicle.

What is claimed is:

1. An electromagnetic braking cylinder comprising:
a cylinder part comprising first and second surfaces and an extending portion, the first and second surfaces facing each other and forming a first receiving space, the extending portion vertically extending from the second surface and forming a second receiving space;
a piston part received inside of the first and second receiving spaces, and moving back and forth along the extending part; and
an electromagnetic force generating part comprising first and second electromagnetic parts respectively fixed to the cylinder part and the piston part and moving the piston part according as an electromagnetic force is applied, one of the first and second electromagnetic parts comprising a permanent magnet.

2. The electromagnetic braking cylinder of claim 1, wherein the piston part comprises:
a bottom portion received by the first receiving space, dividing the first receiving space into first and second sub receiving spaces, and extending parallel with the first and second surfaces; and
an axis portion received by the second sub receiving space and the second receiving space, and extending parallel with the extending portion.

3. The electromagnetic braking cylinder of claim 2, wherein the first electromagnetic part is fixed to the first surface and the second electromagnetic part is fixed to the bottom portion, and thus the first and second electromagnetic parts are disposed facing each other in the first sub receiving space.

4. The electromagnetic braking cylinder of claim 3, further comprising:
an elastic element fixed to the second sub receiving space between the bottom portion and the second surface.

5. The electromagnetic braking cylinder of claim 1, wherein one of the first and second electromagnetic parts is the permanent magnet, and the remaining of the first and second electromagnetic parts is an electromagnet or a hybrid electromagnet.

6. The electromagnetic braking cylinder of claim 1, further comprising:
a control part changing a current or a voltage applied to the electromagnetic force generating part to control an intensity of an electromagnetic force of the electromagnetic force generating part.

7. The electromagnetic braking cylinder of claim 2, further comprising:
a heat dissipating part connected to the electromagnetic force generating part and dissipating a heat generated from the electromagnetic force generating part.

8. The electromagnetic braking cylinder of claim 1, further comprising:
a control unit connected to the piston part and applying a pressure to a target part to control the target part.
